(19) United States
(12) Patent Application Publication
(10) Pub. No.: US 2025/0042480 A1
(43) Pub. Date: Feb. 6, 2025

(54) UNDERBODY SHIELDS AND OTHER ARTICLES WITH LAMINATED FIBER REINFORCEMENT

(71) Applicant: HANWHA AZDEL, INC., Forest, VA (US)

(72) Inventors: Cory Dubrish, Forest, VA (US); Anthony J Messina, Forest, VA (US)

(21) Appl. No.: 18/629,419

(22) Filed: Apr. 8, 2024

Related U.S. Application Data
(60) Provisional application No. 63/457,892, filed on Apr. 7, 2023.

(51) Int. Cl. B62D 29/04; B32B 5/26; B32B 27/06; B32B 27/12; B32B 27/18

(52) U.S. Cl. CPC B62D 29/041; B32B 5/26; B32B 27/065; B32B 27/12; B32B 27/18; B32B 2250/05; B32B 2260/021; B32B 2262/0269; B32B 2262/0276; B32B 2262/101; B32B 2262/12; B32B 2605/08

(57) ABSTRACT

Thermoplastic composite articles are described that comprise one or more reinforcement layers that can provide impact resistance. In certain arrangements, the thermoplastic composite article can include a lightweight porous core layer that includes a web of open celled structures comprising random crossing over of a plurality of reinforcing fibers held together by a thermoplastic material. A reinforcement layer can be laminated to the porous core layer to provide enhanced impact resistance.

### PRIORITY APPLICATION

This application is related to and claims priority to and the benefit of U.S. Application No. 63/457,892 filed on Apr. 7, 2023, the entire disclosure of which is hereby incorporated herein by reference.

### TECHNOLOGICAL FIELD

Impact resistant underbody shields that include fiber reinforcement layers laminated to a lightweight porous core layer are described. In some configurations, the underbody shields includes a lightweight porous core layer in combination with one or more lightweight fiber reinforcement layers.

### BACKGROUND

Composite articles often include various materials that impart desired properties to the articles. Many composite articles are subject to impacts that can damage the article and reduce the lifetime of the article.

### SUMMARY

Certain aspects and features are described in reference to composite articles and underbody shield that can include a porous core layer in combination with a fiber reinforcement layer that provides impact resistance to the articles and underbody shields. The articles and underbody shields can be lighter than conventional articles and underbody shields while still providing impact resistance.

In an aspect, an impact resistant thermoplastic composite article comprises a porous core layer comprising a web of reinforcing fibers held in place by a thermoplastic material, a first skin disposed on a first surface of the porous core layer, and a second skin disposed on a second surface of the porous core layer, wherein the second skin comprises a matrix comprising a plurality of arranged fibers held in place by a thermoplastic material, and wherein the second skin provides impact resistance to the thermoplastic composite article to permit the thermoplastic composite article to pass a gravelometer test.

In certain embodiments, the plurality of arranged fibers of the second skin comprise a unidirectional arrangement of the fibers in a single ply or in at least two plys. In some embodiments, the plurality of arranged fibers of the second skin are selected from the group consisting of glass fibers, carbon fibers, organic fibers, inorganic fibers, bicomponent fibers, and combinations and blends thereof.

In certain configurations, the plurality of arranged fibers of the second skin comprise a bidirectional arrangement of the fibers in a single ply or in at least two plys. In other configurations, the plurality of arranged fibers of the second skin are selected from the group consisting of glass fibers, carbon fibers, organic fibers, inorganic fibers, bicomponent fibers and combinations and blends thereof.

In certain embodiments, the porous core layer comprises a basis weight between 300 gsm and 2000 gsm or between 450 gsm and 1400 gsm. In other embodiments, the first skin is a scrim or a film comprising a basis weight from 15 gsm to 110 gsm. In some embodiments, the second skin comprises a basis weight up to 500 gsm, and wherein the thermoplastic material of the second skin is polypropylene, polyethylene terephthalate or an amorphous polyethylene terephthalate.

In some arrangements, the thermoplastic material of the porous core layer comprises at least one of a polyethylene, a polypropylene, a polystyrene, a polyimide, a polyetherimide, an a acrylonitrylstyrene, a butadiene, a polyethylene terephthalate, polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures and copolymers thereof.

In other arrangements, the reinforcing fibers of the porous core layer are selected from the group consisting of glass fibers, carbon fibers, graphite fibers, synthetic organic fibers, inorganic fibers, bicomponent fibers, natural fibers, mineral fibers, metal fibers, metalized inorganic fibers, metalized synthetic fibers, ceramic fibers, and combinations and blends thereof.

In certain embodiments, the impact resistant thermoplastic composite article comprises an adhesive tie layer between the second skin and the second surface of the porous core layer.

In some embodiments, the adhesive tie layer comprises a thermoplastic material. In other embodiments, the thermoplastic material of the adhesive tie layer comprises a polyolefin. In certain examples, the plurality of arranged fibers of the second skin comprise a unidirectional arrangement of the fibers in a single ply or in at least two plys.

In certain examples, the plurality of arranged fibers of the second skin are selected from the group consisting of glass fibers, carbon fibers, organic fibers, inorganic fibers, bicomponent fibers, and combinations and blends thereof.

In some embodiments, the plurality of arranged fibers of the second skin comprise a bidirectional arrangement of the fibers in a single ply or in at least two plys. In other embodiments, the plurality of arranged fibers of the second skin are selected from the group consisting of glass fibers, carbon fibers, organic fibers, inorganic fibers, bicomponent fibers and combinations and blends thereof.

In some embodiments, the porous core layer comprises a basis weight between 300 gsm and 1000 gsm or between 300 gsm and 800 gsm.

In certain embodiments, the first skin is a scrim or a film comprising a basis weight up to 20 gsm.

In other embodiments, the second skin comprises a basis weight up to 500 gsm, and the thermoplastic material of the second skin is polypropylene, polyethylene terephthalate or an amorphous polyethylene terephthalate.

In another aspect, an impact resistant underbody shield configured to couple to an underside of a vehicle is described. For example, the impact resistant underbody shield comprises a porous core layer comprising a web of reinforcing fibers held in place by a thermoplastic material, a first skin disposed on a first surface of the porous core layer, wherein the first skin is adjacent to an undercarriage of the vehicle as an undercarriage surface of the underbody shield, and a second skin disposed on a second surface of the porous core layer, wherein the second skin is adjacent to a road facing surface of the impact resistant underbody shield and is exposed to the road,

In certain embodiments, the second skin comprises a matrix comprising a plurality of arranged fibers held in place by a thermoplastic material, wherein the second skin provides impact resistance to the road facing surface of the impact resistant underbody shield to permit the underbody shield to pass a gravelometer test. In certain configurations, the impact resistant underbody shield comprises at least one three-dimensional drawn area.

In some embodiments, an adhesive tie layer is present between the second skin and the second surface of the porous core layer. In some configurations, the adhesive tie layer comprises a thermoplastic material. In other embodiments, the thermoplastic material of the adhesive tie layer comprises a polyolefin.

In certain configurations, the plurality of arranged fibers of the second skin comprise a unidirectional arrangement of the fibers in a single ply or in at least two plys. In some embodiments, the plurality of arranged fibers of the second skin are selected from the group consisting of glass fibers, carbon fibers, organic fibers, inorganic fibers, bicomponent fibers, and combinations and blends thereof.

In other embodiments, the plurality of arranged fibers of the second skin comprise a bidirectional arrangement of the fibers in a single ply or in at least two plys. In certain embodiments, the plurality of arranged fibers of the second skin are selected from the group consisting of glass fibers, carbon fibers, organic fibers, inorganic fibers, bicomponent fibers and combinations and blends thereof.

In certain configurations, the porous core layer comprises a basis weight between 300 gsm and 2000 gsm or between 450 gsm and 1400 gsm.

In other configurations, the first skin is a scrim or a film comprising a basis weight from 15 gsm to 110 gsm.

In some embodiments, the second skin comprises a basis weight up to 500 gsm, and the thermoplastic material of the second skin is polypropylene, polyethylene terephthalate or an amorphous polyethylene terephthalate.

Additional aspects, embodiments, configurations, examples, features and elements are described in more detail below.

### BRIEF DESCRIPTION OF THE SEVERAL VIEWS OF THE DRAWINGS

Certain specific illustrations are described in reference to the accompanying figures in which:

FIG. 1 is an illustration showing a porous core layer and a fiber reinforcement layer, in accordance with certain embodiments;

FIG. 2 is a three-dimensional illustration showing a fiber reinforcement layer with a 0 degree angle fiber arrangement, in accordance with certain embodiments;

FIG. 3 is a three-dimensional illustration showing a fiber reinforcement layer with a 90 degree angle fiber arrangement, in accordance with certain embodiments;

FIG. 4 is an illustration showing a fiber reinforcement layer with a 45 degree angle fiber arrangement, in accordance with certain embodiments;

FIG. 5 is another illustration showing a fiber reinforcement layer with a 45 degree angle fiber arrangement, in accordance with certain embodiments;

FIG. 6 is an illustration showing a fiber reinforcement layer with differently angled fiber arrangements, in accordance with certain embodiments;

FIG. 7 is an illustration showing a fiber reinforcement layer with different fiber densities at different areas, in accordance with certain embodiments;

FIG. 8 is an illustration showing a fiber reinforcement layer with different fiber densities and different fiber angles at different areas, in accordance with certain embodiments;

FIG. 9 is another illustration showing a fiber reinforcement layer with different fiber densities and different fiber angles at different areas, in accordance with certain embodiments;

FIG. 10 is an illustration showing a two-ply arrangement of 0/0 angled fibers, in accordance with certain embodiments;

FIG. 11 is an illustration showing a two-ply arrangement of 90/0 angled fibers, in accordance with certain embodiments;

FIG. 12 is an illustration showing a two-ply arrangement of 45/0 angled fibers, in accordance with certain embodiments;

FIG. 13 is an illustration showing a two-ply arrangement of +45/−45 angled fibers, in accordance with certain embodiments;

FIG. 14 is an illustration showing a three-ply arrangement of angled fibers, in accordance with certain embodiments;

FIG. 15 is an illustration showing a four-ply arrangement of angled fibers, in accordance with certain embodiments;

FIG. 16 is an illustration showing a composite article including a porous core layer, a fiber reinforcement layer and a skin layer, in accordance with certain embodiments;

FIG. 17 is an illustration showing a composite article including a porous core layer, a fiber reinforcement layer, an adhesive layer and a skin layer, in accordance with certain embodiments;

FIG. 18 is an illustration showing a composite article including a porous core layer, a fiber reinforcement layer, an adhesive layer and a skin layer, in accordance with certain embodiments;

FIG. 19 is an illustration showing a composite article including a porous core layer, a fiber reinforcement layer, adhesive layers and a skin layer, in accordance with certain embodiments;

FIG. 20 is an illustration showing a composite article including a porous core layer, a fiber reinforcement layer, an adhesive layer, a decorative layer and a skin layer, in accordance with certain embodiments;

FIG. 21 is an illustration showing a composite article including two porous core layers, a fiber reinforcement layer, an adhesive layer, and a skin layer, in accordance with certain embodiments;

FIG. 22 is an illustration of a headliner, in accordance with certain embodiments;

FIG. 23 is an illustration of an underbody shield, in accordance with certain embodiments;

FIG. 24 is an illustration of interior trim, in accordance with certain embodiments;

FIG. 25 is an illustration of a ceiling panel, in accordance with certain embodiments;

FIG. 26 is an illustration of a cubicle panel, in accordance with certain embodiments;

FIG. 27 is an illustration of a structural panel, in accordance with certain embodiments;

FIG. 28 is another illustration of a structural panel, in accordance with certain embodiments;

FIG. 29 is an illustration of a wall panel, in accordance with certain examples;

FIG. 30 is an illustration of a siding panel, in accordance with certain examples;

FIG. 31 is an illustration of a roofing panel, in accordance with certain embodiments;

FIG. 32 is an illustration of a roofing shingle, in accordance with certain embodiments;

FIG. 33 is an illustration of an interior panel of a recreational vehicle, in accordance with certain embodiments;

FIG. 34 is an illustration of an exterior panel of a recreational vehicle, in accordance with certain embodiments;

FIG. 35 is an illustration of an automobile, in accordance with certain embodiments;

FIG. 36 is an illustration of a recreational vehicle, in accordance with certain embodiments;

FIG. 37 is an illustration of an airplane, in accordance with certain embodiments; and

FIG. 38 is an illustration of a space capsule, in accordance with certain embodiments.

FIG. 39 is an illustration of an interior trim, in accordance with certain embodiments;

It will be recognized by the person having ordinary skill in the art, given the benefit of this disclosure that the dimensions, sizes, shading, arrangement and other features in the figures are provided merely for illustration and are not intended to limit the technology to any one configuration, dimension or arrangement. Each layer need not have the same thickness or dimensions as the other layers, even though certain figures may show similar thicknesses or dimensions for case or illustration.

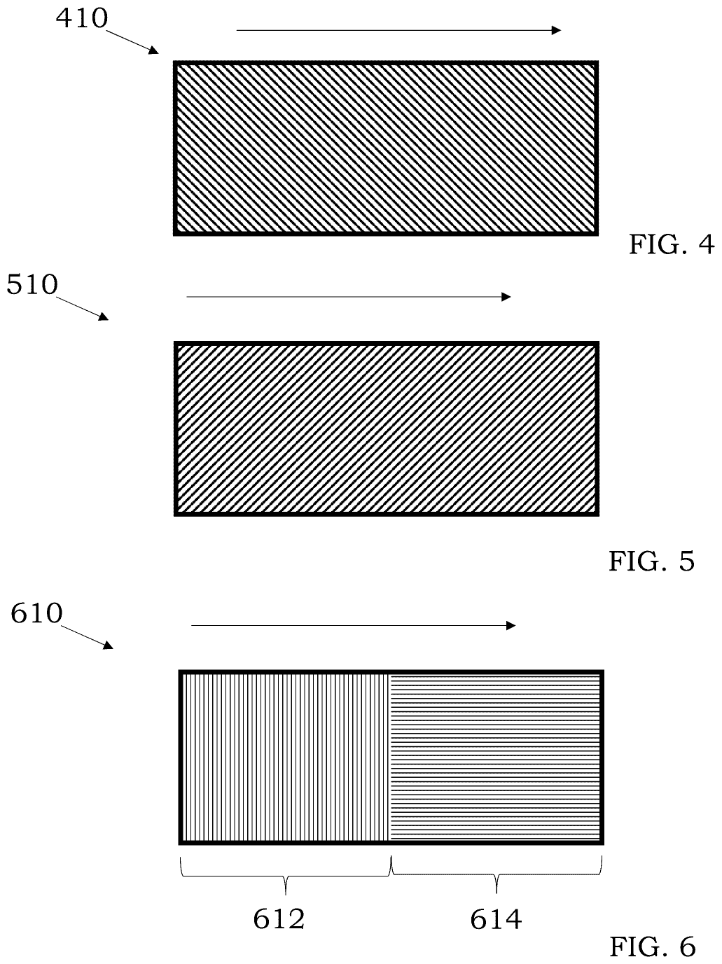

In a typical arrangement, the fibers of the reinforcement layers are oriented in a particular direction/angle when viewed from a top surface of the reinforcement layer. FIG. 2 and FIG. 3 show a three-dimensional view of the fiber arrangement. For case of illustration, the other figures show a two-dimensional arrangement where the fiber orientation is intentionally shown for context. The skilled person, given the benefit of this disclosure, will understand that the fiber arrangement shown in two-dimensional representations is actually the same arrangement shown in FIG. 2 or FIG. 3 when viewed from the top surface of the particular fiber reinforcement layer. In particular, where multiple plys or layers are stacked, a top view would not show the fiber arrangement of the underlying layers.

### DETAILED DESCRIPTION

Various components and features of composite articles and underbody shields that include fiber reinforcement layers are discussed. As noted below, the fiber reinforcement layers can provide enhanced impact resistance, which permits lower basis weights to be used for the various layers present in the thermoplastic composite articles.

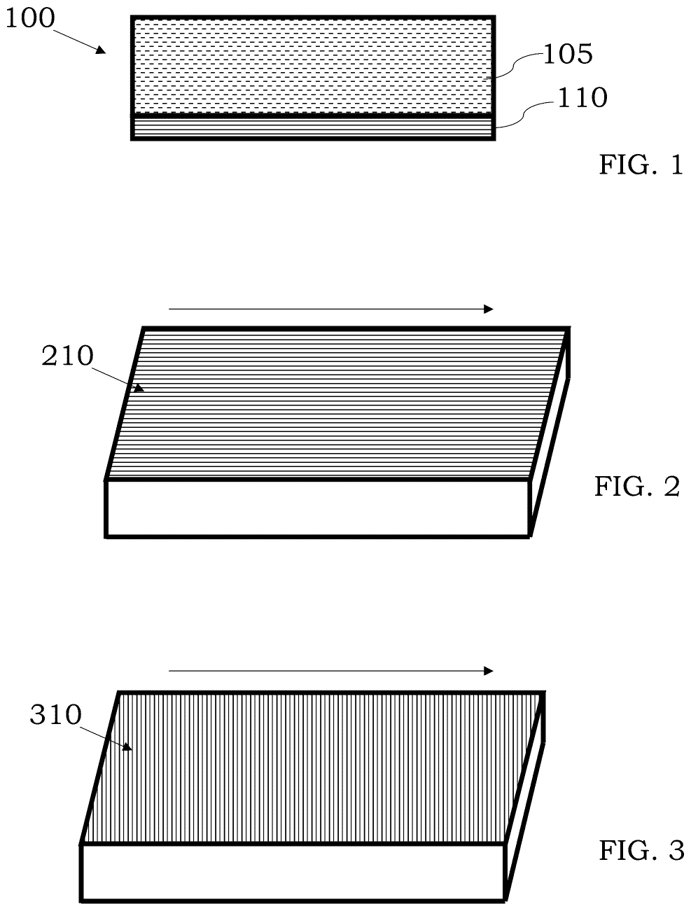

In certain configurations, a thermoplastic composite article can include a porous core layer comprising a web of open celled structures comprising random crossing over of a plurality of reinforcing fibers held together by a thermoplastic material. The article can also include a fiber reinforcement layer disposed on a surface of the porous core layer. In embodiments where the article is configured as an underbody shield, the fiber reinforcement layer is typically present on a “road surface” or facing toward to road such that gravel or other items impact the fiber reinforcement layer in the use environment. Referring to FIG. 1, an article 100 is shown that comprises a porous core layer 105 and a fiber reinforcement layer 110 on a surface of the porous core layer 105. While the reinforcement layer 110 is shown as a single layer for illustration purposes in FIG. 1, as noted below the reinforcement layer 110 make take the form of a single ply, two plys, three ply, four ply, etc. The core layer 105 is typically porous, e.g., is a porous core layer, with a porosity that can vary from more than 0% by volume up to about 95% by volume of the porous core layer. For example, the porous core layer 105 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% by volume of the porous core layer or any illustrative value within these exemplary ranges.

In certain embodiments, the thermoplastic material of the porous core layer 105 can include polyolefin and/or non-polyolefin materials. For example, the thermoplastic material of the core layer 105 comprises one or more of a polyolefin (e.g., one or more of polyethylene, polypropylene, etc.), polystyrene, acrylonitrylstyrene, butadiene, polyethylene-terephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer 105 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the core layer 105. It will be recognized by the skilled person that the weight percentages of all materials used in the core layer 105 will add to 100 weight percent.

In certain configurations, the reinforcing fibers in the porous core layer 105 can include organic reinforcing fibers, inorganic reinforcing fibers or combinations or blends thereof. For example, the reinforcing fibers in the core layer 105 may comprise glass fibers, carbon fibers, graphite fibers, synthetic organic fibers, particularly high modulus organic fibers such as, for example, para- and meta-aramid fibers, nylon fibers, polyester fibers, natural fibers, cellulose fibers, a high melt flow index resin (e.g., 100 g/10 min. MFI to 1400 g/10 min. MFI or above 1400 g/10 min MFI) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In certain embodiments, the fibers used may be cellulose free to avoid or reduce the likelihood of mold or other microbial growth. In some embodiments, the fibers in the core layer 105 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material, the reproduced polymeric fibers or both. The reinforcing fiber content in the core layer 105 may vary from about 10% to about 90% by weight of the core layer, more particularly from about 20% to about 80% by weight, e.g., about 30% to about 70% by weight of the core layer 105. The particular size and/or orientation of the fibers used may depend, at least in part, on the thermoplastic material used and/or the desired properties of the core layer 105. For example, the reinforcing fibers can be randomly oriented or may have a specific selected orientation as desired. In one non-limiting illustration, reinforcing fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm.

In some embodiments, other additives or materials may also be present in the core layer 105. For example, a lofting agent, flame retardants, colorants, smoke suppressants, surfactants, foams or other materials may be present. In some examples, the core layer 105 may substantially halogen free or halogen free core layer to meet the restrictions on hazardous substances requirements for certain applications. In other instances, the core layer may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 105 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 15 weight percent, e.g., about 5 weight percent to about 15 weight percent based on the weight of the core layer. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 15 weight percent, e.g., about 5 weight percent to about 15 weight percent based on the weight of the core layer. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 30 weight percent (based on the weight of the layer), more particularly about 1 weight percent to about 25 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the core layer 105 is formed. In some examples, the flame retardant material may comprise one or more of expandable graphite materials, magnesium hydroxide (MDH) and aluminum hydroxide (ATH).

In some embodiments, a lofting capacity of the core layer 105 can be tuned by including one or more added lofting agents in the core layer 105. The exact type of lofting agent used in the core layer 105 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kurcha Corp. (Japan). In other examples, the lofting agent may be an expandable graphite material or a combination of a microsphere lofting agent with a non-microsphere lofting agent.

In certain embodiments, the fiber reinforcement layer 110 can include fibers oriented in certain directions. The exact orientation of the fibers may vary and is often described with reference to a machine direction. For example, a machine direction can be the direction in which the porous core layer is moving along a support structure during production of the article. As noted herein, the fiber reinforcement layer 110 is typically laminated to the porous core layer after production of the porous core layer or production of a web that leads to the porous core layer. A “0” degree orientation of the fibers is when the fibers are parallel to the machine direction (as shown by the large arrow in FIG. 2). The fibers need not be completely parallel but instead the angle may vary up to about 5 degrees and the fibers would still be considered substantially parallel to the machine direction. FIG. 2 shows a zero degree orientation of the reinforcing fibers in a reinforcement layer 210. The exact type of fibers present in the layer 210 include, but are not limited to, organic reinforcing fibers, inorganic reinforcing fibers, glass fibers, carbon fibers, aramid fibers, metal fibers and combinations or blends thereof. In some embodiments, the fibers may be present as single continuous fibers, whereas in other instances the fibers can be present as long fiber bundles that run from one side of the layer 210 to another side of the layer 210.

In some configurations, the exact fiber density/amount in the layer 210 may vary. In a typical configuration, the fibers are held in the layer 210 by way of a binder or other materials that can retain the fiber orientation. In certain embodiments, the fibers in the layer 210 may be present from 40 weight percent to 85 weight percent and the binder component may be present from 15 weight percent to 60 weigh percent. Fillers or materials other than fibers and binder may also be present. The fibers need not be present in a uniform amount across the surface of the layer 210. For example, edges of the layer 210 may include a higher or lower amount of fibers than fibers present at a central area of the layer 210. Materials other than the reinforcement fibers and the binder may also be present in the layer 210. For example, colorants, dyes, elastomers, flame retardant agents, powders, fillers, whiskers, texturizing agents, crystals, particles and the like can be present in the layer 210 as desired.

In some embodiments, the binder of the layer 210 may be a thermoplastic material, a thermosetting material, an amorphous material, an amorphous thermoplastic material or combinations or blends thereof. In a typical arrangement, the binder material of the layer 210 has a melting point that is either the same as or is higher than a melting point of the thermoplastic material present in the core layer 105. If desired, however, the melting point of the binder of the layer 210 may be lower than a melting point of the thermoplastic material in the core layer 105. Illustrative binder materials that can be present in the layer 210 include, but are not limited to, polyolefins (e.g., polyethylene, polypropylene, etc.), polyesters (polyethylene terephthalate), a polystyrene, a polysulfone, a polyetherimide, a polymethacrylate, and copolymers and combinations and blends thereof. Specific amorphous binder materials include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations and blends thereof.

In some embodiments, the binder of the layer 210 comprises an amorphous material. In general, amorphous materials do not have a sharp melting point when heated. Instead, amorphous materials become less solid and more elastic over a temperature range and are often defined by an average glass transition temperature rather than a specific melting point. Where an amorphous material is present in the layer 210, the average glass transition temperature of the amorphous material can be the same as or can be higher than a melting point of the thermoplastic material present in the core layer 105. Where the average glass transition temperature of the amorphous material is the same as the melting point of the thermoplastic material, the layer 210 can “melt” into the porous core layer to some degree, which can act to adhere the layer 210 to the porous core layer. In other configurations as noted below, an adhesive layer may be present between the core layer and the layer 210.

In certain configurations, the fibers of a fiber reinforcement layer can be arranged at a 90 degree orientation. Referring to FIG. 3, a fiber arrangement is shown where the fibers in a fiber reinforcement layer 310 are oriented 90 degrees or orthogonal to the machine direction (as shown by the large arrow in FIG. 3). A 90 degree arrangement of the fibers is an average arrangement with the exact angle varying by +/−5 degrees. The 90 degree fibers are also oriented substantially parallel to a cross direction, which itself is 90 degrees to the machine direction. The exact type of fibers present in the layer 310 include, but are not limited to, organic reinforcing fibers, inorganic reinforcing fibers, glass fibers, carbon fibers, aramid fibers, metal fibers and combinations and blends thereof. In some embodiments, the fibers may be present as single continuous fibers, whereas in other instances the fibers can be present as long fiber bundles that run from one side of the layer 310 to another side of the layer 310.

In some configurations, the exact fiber density/amount in the layer 310 may vary. As noted below, some configurations used multiple layers or plys each of which includes reinforcing fibers. The fiber density in different layers can be the same or can be different. In a typical configuration, the fibers are held in the layer 310 by way of a binder or other materials that can retain the fiber orientation. In certain embodiments, the fibers in the layer 310 may be present from 40 weight percent to 85 weight percent and the binder component may be present from 15 weight percent to 60 weight percent. The fibers need not be present in a uniform amount across the surface of the layer 310. For example, edges of the layer 310 may include a higher or lower amount of fibers than fibers present at a central area of the layer 310. Materials other than the reinforcement fibers and the binder may also be present in the layer 310. For example, colorants, dyes, elastomers, flame retardant agents, powders, fillers, whiskers, texturizing agents, crystals, particles and the like can be present in the layer 310 as desired.

In some embodiments, the binder of the layer 310 may be a thermoplastic material, a thermosetting material, an amorphous material, an amorphous thermoplastic material or combinations and blends thereof. In a typical arrangement, the binder material of the layer 310 has a melting point that is either the same as or is higher than a melting point of the thermoplastic material present in the core layer 105. Illustrative binder materials that can be present in the layer 310 include, but are not limited to, polyolefins (e.g., polyethylene, polypropylene, etc.), polyesters (polyethylene terephthalate), a polystyrene, a polysulfone, a polyetherimide, a polymethacrylate, and copolymers and combinations and blends thereof. Specific amorphous binder materials include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations and blends thereof.

In some embodiments, the binder of the layer 310 comprises an amorphous material. In general, amorphous materials do not have a sharp melting point when heated. Instead, amorphous materials become less solid and more elastic over a temperature range and are often defined by an average glass transition temperature rather than a specific melting point. Where an amorphous material is present in the layer 310, the average glass transition temperature of the amorphous material can be the same as, lower or higher than a melting point of the thermoplastic material present in the core layer 105. Where the average glass transition temperature of the amorphous material is the same as the melting point of the thermoplastic material, the layer 310 can “melt” into the porous core layer to some degree, which can act to adhere the layer 310 to the porous core layer. In other configurations as noted below, an adhesive layer may be present between the core layer and the layer 310.

In certain embodiments, the fibers in the reinforcement layer 110 need not be arranged at only 0 degrees or 90 degrees. For example, the fibers can be arranged at any angle between these values but are not randomly arranged at multiple different angles. FIG. 4 and FIG. 5 show a 45 degree arrangement of fibers in reinforcement layers 410, 510, respectively. The fibers could instead be present at other angles including, but not limited to, 5 degrees, 10 degrees, 15 degrees, 20 degrees, 25 degrees, 30 degrees, 35 degrees, 40 degrees, 50 degrees, 55 degrees, 60 degrees, 65 degrees, 70 degrees, 75 degrees, 80 degrees, 85 degrees or any value between these values.

In certain embodiments, the reinforcement layers described herein can include more than a single type of fiber. For example, glass fibers may be present in combination with non-glass fibers in the reinforcement layer. The different types of fibers may be present in an intermixed fashion with different fiber types being adjacent to each other across a surface of the layer or may be present in a segregated manner with one type of fiber being present in one area or areas of the reinforcement layer and a second type of fibers being present in other areas of the reinforcement layer.

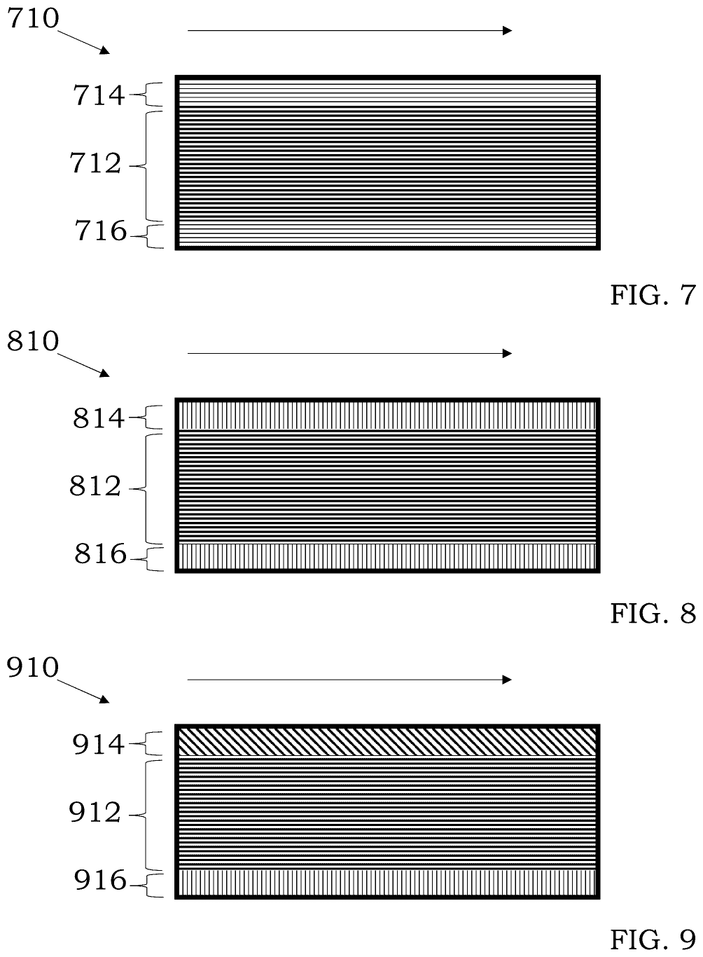

In some configurations, a single reinforcement layer may have two different fiber arrangements or different fiber densities within the same layer. An illustration is shown in FIG. 6, where a first area 612 of a reinforcement layer 610 comprises a 90 degree arrangement of fibers and a second area 614 comprises a 0 degree arrangement of fibers. Another illustration is shown in FIG. 7, where a reinforcement layer 710 comprises a central area 712 with a 0 degree fiber arrangement having a higher density than 0 degree arranged fibers at areas 714, 716. An additional arrangement is shown in FIG. 8, where a reinforcement layer 810 comprises a central area 812 with a 0 degree fiber arrangement having a higher density than 90 degree arranged fibers at areas 814, 816. The fiber arrangement need not be symmetric across a surface of the reinforcement layers. For example and referring to FIG. 9, a reinforcement layer is shown that comprises fibers at edges with different orientations. The fibers at a central area 912 have a 0 degree orientation, the fibers at an area 914 have a 45 degree orientation, and the fibers at an area 916 have a 90 degree orientation. Other configurations of different fiber arrangement in a single reinforcement layer and/or different fiber densities within a single reinforcement layer are also possible.

In certain embodiments, the reinforcement layers described herein, e.g., layers 110, 210, 310, 410, 510, 610, 710, 810 and 910, are typically non-porous, e.g., have 0% porosity. If desired, however, certain areas of the reinforcement layers can be porous, permeable or open to air flow. In use of the reinforcement layers in composite articles, the final reinforcement layer present after production of the composite article is typically non-porous and comprises the reinforcing fibers in combination with a binder and optionally other materials. The reinforcement layer may be water or moisture resistant and/or waterproof if desired.

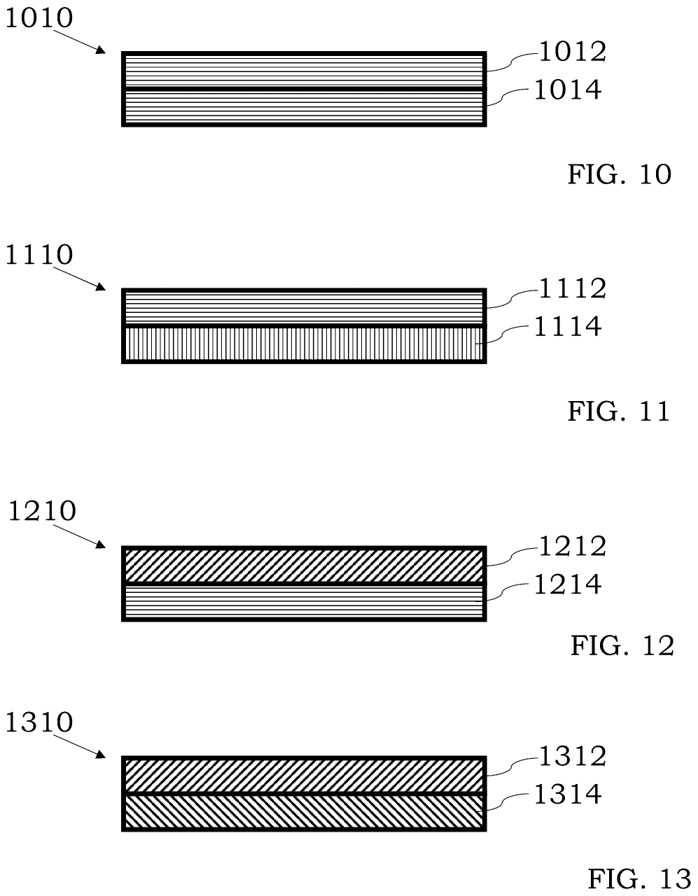

In certain embodiments, two or more reinforcement layers can be used with each other. For example, a two-ply, three-ply, four-ply or multi-ply arrangements of reinforcement layers can be present on a surface of a porous core layer. Various illustrations are shown in FIGS. 10-13. Each ply can be laminated individually to the porous core layer, multiple plys may be stacked on the porous core layer and then lamination may occur, or multiple plys can be laminated to each other prior to addition, and subsequent lamination, of the ply assembly to a porous core layer.

Referring to FIG. 10, a side view of a two-ply arrangement 1010 is shown where a first ply 1012 comprises a 0 degree arrangement of fibers and a second ply 1014 comprises a 0 degree arrangement of fibers. The fibers and binder in the layers 1012, 1014 can be different or the same. In some embodiments, the fibers and binder in each layer 1012, 1014 can be the same but the fiber density may be different in one of the layers 1012, 1014. Either of the layers 1012, 1014 can be adjacent to a core layer as desired. Another illustration of a two-ply arrangement 1110 is shown in FIG. 11 where a 0 degree fiber layer 1112 is coupled to a 90 degree fiber layer 1114. Either of the layers 1112, 1114 can be adjacent to a core layer as desired. Another illustration of a two-ply arrangement 1210 is shown in FIG. 12 where a 45 degree fiber layer 1212 is coupled to a 0 degree fiber layer 1214. Either of the layers 1212, 1214 can be adjacent to a core layer as desired. Another illustration of a two-ply arrangement 1210 is shown in FIG. 13 where a +45 degree fiber layer 1312 is coupled to a −45 degree fiber layer 1314. Either of the layers 1312, 1314 can be adjacent to a core layer as desired. While the fibers are arranged 45 degrees relative to the machine direction in FIG. 13, the fibers in the layer 1312 are arranged at a positive 45 degree angle and the fibers in the layer 1314 are arranged at a negative 45 degree angle. Additional fiber angles in two-ply arrangements are also possible.

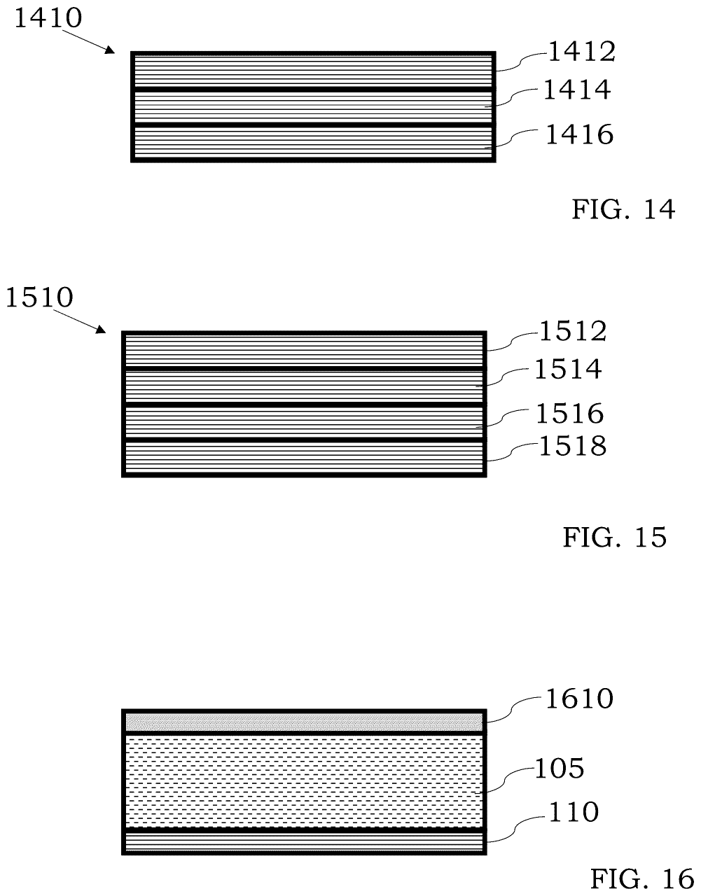

In certain embodiments, three ply arrangements of reinforcing layers may be used in the composite articles described herein. Referring to FIG. 14, an illustration is shown where a three ply arrangement 1410 comprises reinforcement layers 1412, 1414, and 1416. Each of the reinforcement layers 1412, 1414, 1416 may comprise the same or a different arrangement of fibers and may comprise the same or different binder material. In one example, the angle of the fibers in the layers 1412/1414/1416 is 0/0/0, respectively. In another example, the angle of the fibers in the layers 1412/1414/1416 is 0/90/0, respectively. In another example, the angle of the fibers in the layers 1412/1414/1416 is 0/90/90, respectively. In another example, the angle of the fibers in the layers 1412/1414/1416 is 0/0/90, respectively. In another example, the angle of the fibers in the layers 1412/1414/1416 is 90/0/90, respectively. In another example, the angle of the fibers in the layers 1412/1414/1416 is 90/0/0, respectively. In another example, the angle of the fibers in the layers 1412/1414/1416 is 0/0/90, respectively. In another example, the angle of the fibers in the layers 1412/1414/1416 is 0/90/0, respectively.

In some examples, the layer 1412 comprises a 0 degree angle of fibers, and the fibers in the layers 1414, 1416 are each independently between 0 degrees and 90 degrees. In other examples, the layer 1412 comprises a 90 degree angle of fibers, and the fibers in the layers 1414, 1416 are each independently between 0 degrees and 90 degrees. In some examples, the layer 1412 comprises a non-zero degree angle of fibers (greater than 0 and up to 90), and the fibers in the layers 1414, 1416 are each independently between 0 degrees and 90 degrees. In some examples, the layer 1414 comprises a 0 degree angle of fibers, and the fibers in the layers 1412, 1416 are each independently between 0 degrees and 90 degrees. In other examples, the layer 1414 comprises a 90 degree angle of fibers, and the fibers in the layers 1412, 1416 are each independently between 0 degrees and 90 degrees. In some examples, the layer 1412 comprises a non-zero degree angle of fibers (greater than 0 and up to 90), and the fibers in the layers 1412, 1416 are each independently between 0 degrees and 90 degrees. In some examples, the layer 1416 comprises a 0 degree angle of fibers, and the fibers in the layers 1412, 1414 are each independently between 0 degrees and 90 degrees. In other examples, the layer 1416 comprises a 90 degree angle of fibers, and the fibers in the layers 1412, 1414 are each independently between 0 degrees and 90 degrees. In some examples, the layer 1416 comprises a non-zero degree angle of fibers (greater than 0 and up to 90), and the fibers in the layers 1412, 1414 are each independently between 0 degrees and 90 degrees. In certain embodiments, each of the layers 1412, 1414, and 1416 independently comprises any fiber arrangement between 0 degrees and 90 degrees. If desired, one or two of the layers 1412, 1414 and 1416 may comprise a random arrangement of fibers. In use of the three ply arrangement 1410, either layer 1412 or layer 1416 can be placed adjacent to a porous core layer.

In certain configurations, four ply arrangements of reinforcing layers may be used in the composite articles described herein. Referring to FIG. 15, an illustration is shown where a three ply arrangement 1510 comprises reinforcement layers 1512, 1514, 1516 and 1518. In some embodiments, the layer 1512 comprises a fiber arrangement of 0 degrees, and each of the layers 1514, 1516 and 1518 comprises a fiber arrangement of 0 degrees to 90 degrees. In other embodiments, the layer 1512 comprises a fiber arrangement of 90 degrees, and each of the layers 1514, 1516 and 1518 comprises a fiber arrangement of 0 degrees to 90 degrees. In some embodiments, the layer 1514 comprises a fiber arrangement of 0 degrees, and each of the layers 1512, 1516 and 1518 comprises a fiber arrangement of 0 degrees to 90 degrees. In other embodiments, the layer 1514 comprises a fiber arrangement of 90 degrees, and each of the layers 1512, 1516 and 1518 comprises a fiber arrangement of 0 degrees to 90 degrees. In some embodiments, the layer 1516 comprises a fiber arrangement of 0 degrees, and each of the layers 1512, 1514 and 1518 comprises a fiber arrangement of 0 degrees to 90 degrees. In other embodiments, the layer 1516 comprises a fiber arrangement of 90 degrees, and each of the layers 1512, 1514 and 1518 comprises a fiber arrangement of 0 degrees to 90 degrees. In some embodiments, the layer 1518 comprises a fiber arrangement of 0 degrees, and each of the layers 1512, 1514 and 1516 comprises a fiber arrangement of 0 degrees to 90 degrees. In other embodiments, the layer 1518 comprises a fiber arrangement of 90 degrees, and each of the layers 1512, 1514 and 1516 comprises a fiber arrangement of 0 degrees to 90 degrees.

In some embodiments, a fiber angle of 0 degrees is present in at least two of the layers 1512, 1514, 1516 and 1518. In other embodiments, a fiber angle of 90 degrees is present in at least two of the layers 1512, 1514, 1516 and 1518. In some embodiments, a fiber angle of greater than 0 degrees and less than 90 degrees is present in at least two of the layers 1512, 1514, 1516 and 1518. In other embodiments, a fiber angle of 0 degrees is present in at least three of the layers 1512, 1514, 1516 and 1518. In some embodiments, a fiber angle of 90 degrees is present in at least three of the layers 1512, 1514, 1516 and 1518. In other embodiments, a fiber angle of greater than 0 degrees and less than 90 degrees is present in at least three of the layers 1512, 1514, 1516 and 1518. In some examples, the layers 1512 and 1518 may comprise a 0 degree fiber angle and the layers 1514, 1516 may comprise any fiber angle from 0 degrees up to 90 degrees. In other examples, the layers 1512 and 1518 may comprise a 90 degree fiber angle and the layers 1514, 1516 may comprise any fiber angle from 0 degrees up to 90 degrees.

In other examples, the layers 1512 and 1518 may comprise an angle greater than 0 and up to 90 degrees and the layers 1514, 1516 may comprise any fiber angle from 0 degrees up to 90 degrees. In some examples, the layers 1514 and 1516 may comprise a 0 degree fiber angle and the layers 1512, 1518 may comprise any fiber angle from 0 degrees up to 90 degrees. In other examples, the layers 1514 and 1516 may comprise a 90 degree fiber angle and the layers 1512, 1518 may comprise any fiber angle from 0 degrees up to 90 degrees. In other examples, the layers 1514 and 1516 may comprise an angle greater than 0 and up to 90 degrees and the layers 1512, 1518 may comprise any fiber angle from 0 degrees up to 90 degrees. Specific fiber arrangements of the layers 1512/1514/1516/1518 include for example: 0/0/0/0, 0/90/0/0, 0/90/90/0, 0/90/90/90, 90/0/0/0, 90/90/0/0, 90/90/90/0, 90/0/0/90, 90/90/90/90, 0/0/90/0, 0/0/90/90. 90/0/90/90, 90/90/0/90, and 0/x/y/z, 90/x/y/z where x, y and z are independently any angle between 0-90 degrees. In use of the four ply arrangement 1510, either layer 1512 or layer 1518 can be placed adjacent to a porous core layer.

In certain embodiments, five ply, six ply, seven ply, eight ply, ten ply or more can be used in the composite articles described herein. In some configurations, a basis weight of each ply may vary depending on the number of plys present in the composite article. In some embodiments, each reinforcement layer may comprise a basis weight between 100 g/m² (or gsm) to 800 g/m². As more plys are present, the basis weight of each reinforcement layer generally decreases to reduce the overall weight of the composite article. Each layer in a multi-ply arrangement can include any of those fibers and binders described in reference to the layers 210, 310. For example, the fibers in each layer of a multi-ply arrangement can independently be organic reinforcing fibers, inorganic reinforcing fibers, glass fibers, carbon fibers, aramid fibers, metal fibers and combinations and blends thereof. The amount of the fibers in each layer of a multiply arrangement may vary from 40 weight percent to 85 weight percent and the binder component may be present from 15 weight percent to 60 weight percent. Fillers or other materials may also be present. The fibers need not be present in a uniform amount across the surface of the each layer in the ply. Materials other than the reinforcement fibers and the binder may also be present in each layer of the multiply arrangement. For example, colorants, dyes, elastomers, flame retardant agents, powders, fillers, whiskers, texturizing agents, crystals, particles and the like can be present in each layer as desired. The binder of each layer of a multiply arrangement may be a thermoplastic material, a thermosetting material, an amorphous material, an amorphous thermoplastic material or combinations and blends thereof. In a typical arrangement, the binder material in each the layer of a multiply arrangement has a melting point that is either the same as or is higher than a melting point of the thermoplastic material present in the core layer 105. Illustrative binder materials that can be present in each layer of a multiply arrangement include, but are not limited to, polyolefins (e.g., polyethylene, polypropylene, etc.), polyesters (polyethylene terephthalate), a polystyrene, a polysulfone, a polyetherimide, a polymethacrylate, and copolymers and combinations and blends thereof. Specific amorphous binder materials include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations and blends thereof.

In certain embodiments, the thermoplastic composite article can include an additional layer on a second surface of the porous core layer. Referring to FIG. 16, an article 1600 is shown that comprises an additional layer or skin layer 1610 on a second surface of the porous core layer 105 opposite where the reinforcement layer 110 is present. The additional layer 1610 can include many different materials and may adopt many different configurations. The layer 1610 can be joined to the core 105 through an adhesive layer or can be joined to the core without any adhesive layer. In certain embodiments, the additional layer 1610 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the layer 1610 may comprise natural fibers, polymeric fibers, or other materials. In other instances, the layer 1610 may comprise a limiting oxygen index greater than about 22, as measured per ISO 4589 dated 1996. Where a thermoplastic film is present as (or as part of) the layer 1610, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the layer 1610, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 1610, the coating may comprise at least one of unsaturated polyurethanes, vinyl esters, phenolics and epoxies. Where an inorganic coating is present as (or as part of) the layer 1610, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 1610, the non-woven fabric may comprise a thermoplastic material, a thermal setting binder, inorganic fibers, metal fibers, metallized inorganic fibers and metallized synthetic fibers. If desired, the additional layer 1610 may comprise one or more reinforcement layers as described herein. For example, a reinforcement layer with an arrangement of fibers can also be present as the layer 1610. The reinforcement layer may be present as a single ply or as a multiply arrangement as desired.

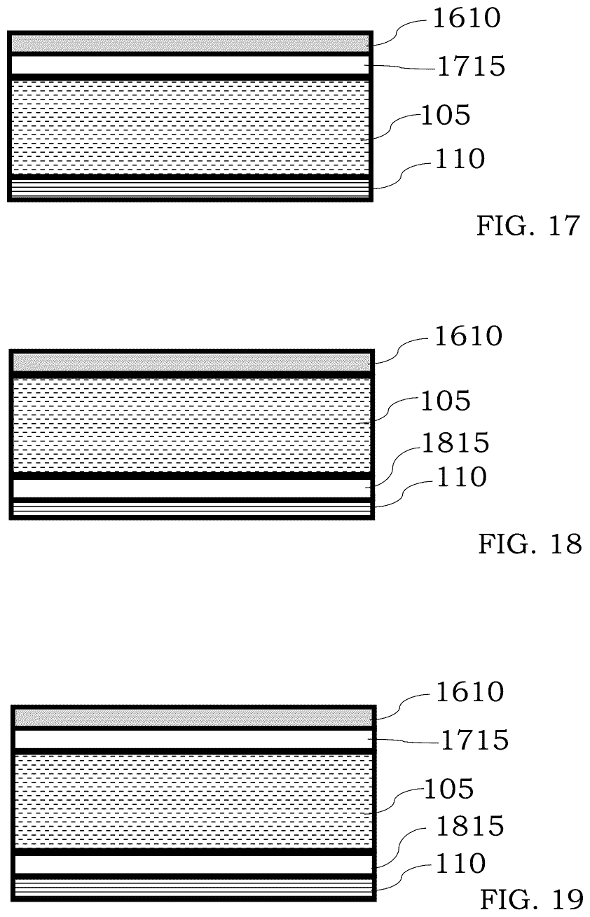

In some embodiments, the layer 1610 may be coupled to the core layer 105 through an adhesive layer 1715 as shown in FIG. 17. The adhesive layer 1715 can include thermoplastic materials and/or thermosetting materials as desired. For example, one or more thermoplastic polymer adhesives may be used. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations and blends thereof.

In some configurations, the fiber reinforcement layer 110 can be coupled to the core layer 105 through an adhesive or tie layer as shown in FIG. 18 and FIG. 19, where the adhesive layer 1715 is present between the additional layer 1610 and the core layer 105. The adhesive layer 1815 can include thermoplastic materials and/or thermosetting materials as desired. For example, one or more thermoplastic polymer adhesives may be used. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations and blends thereof. The adhesive layer 1815 is optional and may be omitted when the fiber reinforcement layer 110 bonds to the porous core layer 105 in a sufficient manner.

In use of the composite articles shown in FIGS. 17-19, the fiber reinforcement layer 110 typically is exposed or is positioned suitably to absorb impacts in the use environment of the composite article. For example, when the article is configured as an underbody shield, the additional layer 1610 can face toward an underside of an engine, and the reinforcement layer 110 can face toward a road surface. The fiber reinforcement layer 110 can provide impact resistance such that foreign bodies that are incident on the surface of the composite article do not result in delamination or destruction of the composite article. Impact resistance can vary depending on the particular end use of the composite article.

In certain embodiments, where the composite article is configured as an underbody shield, impact resistance can be measured by a gravelometer test. A gravelometer test is described in SAE Standard J400 dated Oct. 23, 2012, which is similar to ASTM D3170-14 dated Jul. 1, 2014. Gravelometer tests are also described in GMW 14700 and ISO-20567-1. For example, the materials can be used to produce a composite article that can withstand 50 or more individual impacts, e.g., 100 or more individual impacts, as provided under the gravelometer test conditions, without any substantial damage or effects to the article. Alternatively, a gravelometer test can measure the weight of gravel. Typically a test will use 100 kg of gravel to be shot at a test part (150 kg for ISO-20567-1). The part passes if it can withstand the impacts of the total amount of gravel used.

The composite article can be tested according to the SAE J400 test and may be considered to pass the test if the number of impact cycles exceeds a desired value, e.g., greater than or equal to 50 impacts by individual stones, gravels or equivalent flying objects, greater than or equal to 100 impacts by individual stones, gravels or equivalent flying objects, greater than or equal to 200 impacts by individual stones, gravels or equivalent flying objects, or greater than or equal to 300 impacts by individual stones, gravels or equivalent flying objects. Alternatively, a total weight of gravel may be used to impact the part. In the test procedure, sample plaques of 100 mm×300 mm can be placed in a holder with the back side supported against a steel plate. Stones can be projected at the plaques at 90 degrees or perpendicular to the surface. The stones can be water eroded alluvial road gravel 8 to 16 mm in size. Stones can be fed through the air stream with an 8±2 seconds interval at an air pressure of 70 psi. Every 10 cycles the specimen can be taken out for observation. Any cracking, blistering, delamination, or erosion through the outer surface indicates failure. The test can be continued until any of the above mentioned failure is observed.

In another arrangement, a specimen size of about 100 mm by 150 mm is placed in a holder with the angle of the projectiles being 45 degrees, 54 degrees, or 90 degrees. A selected amount of the gravel is launched to impact the surface of the specimen. Any cracking, blistering, delamination, or erosion through the outer surface indicates failure.

In other instances, impact resistance can be measured according to other tests including, but not limited to, ASTM D5420-21 (falling weight impact test), ASTM D2794-1993 (R2019) (falling weight from various heights) or other tests which can subject a surface to impact, indenting or falling weight.

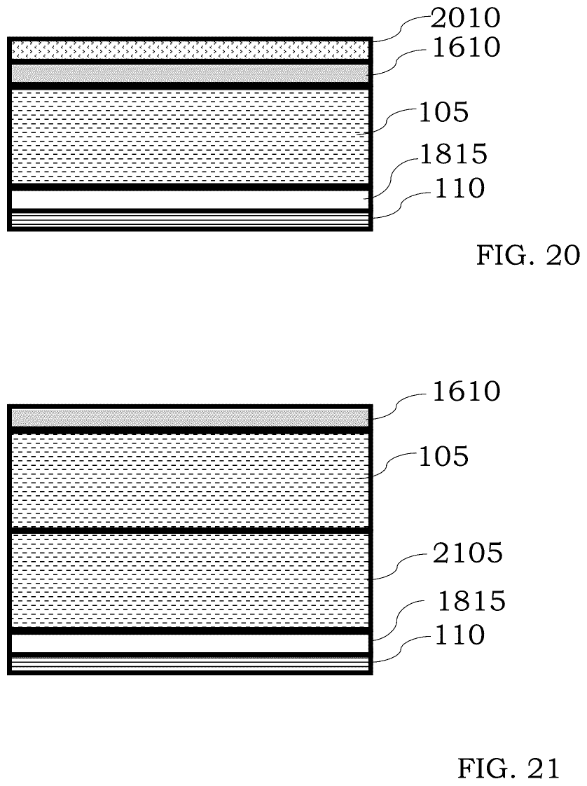

In certain configurations, a composite article can include a decorative layer on one or more surfaces. For example and referring to FIG. 20, fiber reinforced thermoplastic composite can include a decorative layer 2010 on the additional layer 1610. If desired, the layer 1610 can be omitted and the decorative layer can be coupled to the core layer 105. A decorative layer can also be present on the layer 110 if desired. In certain embodiments, the decorative layer 2010 may be formed, e.g., from a thermoplastic film of polyvinyl chloride, polyolefins, thermoplastic polyesters, thermoplastic elastomers, paper, or the like. The decorative layer 2010 may also be a multi-layered structure if desired. For example, a fabric may be bonded to a foam core (or other structures), such as woven fabrics made from natural and synthetic fibers, organic fiber non-woven fabric after needle punching or the like, raised fabric, knitted goods, flocked fabric, or other such materials. The fabric may also be bonded with a thermoplastic adhesive, including pressure sensitive adhesives and hot melt adhesives, such as polyamides, modified polyolefins, urethanes and polyolefins. The decorative layer 2010 may also be produced using spunbond, thermal bonded, spun lace, melt-blown, wet-laid, and/or dry-laid processes. In some embodiments, the decorative layer 2010 may be embossed, textured or otherwise include some pattern or grain structure.

In some embodiments, an adhesive layer (not shown) may optionally be present between the decorative layer 2010 and the additional layer 1610. In instances where an adhesive is desirable, one or more thermoplastic polymer adhesives may be used. For example, it may be desirable to couple the decorative layer 2010 to the layer 1610 using an adhesive. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations and blends thereof.

In certain embodiments, the articles described herein can include two or more core layers. Referring to FIG. 21, an article comprises a first core layer 105 and a second core layer 2105. The reinforcement layer 110 is coupled to the second core layer 2105 through an adhesive layer 1815. The additional layer 1610 is coupled to the first core layer 105. The first core layer 105 and the second core layer 2105 can be the same or can be different. In some embodiments, the first core layer 105 and the second core layer 2105 may comprise the same materials but may have a different thickness or basis weight. In other configurations, the first core layer 105 and the second core layer 2105 may comprise different thermoplastic materials. In additional configurations, the first core layer 105 and the second core layer 2105 may comprise different reinforcing fibers. If desired, more than two core layers can be present in a composite article. In some embodiments, the two core layers 105, 2105 can be separated by a layer such as, for example, a film, a scrim, a reinforcement layer, an adhesive layer or other layers.

In certain embodiments, any one or more of the core layers described herein may be configured as (or used in) a glass mat thermoplastic composite (GMT) or a light weight reinforced thermoplastic (LWRT). The areal density of such a GMT or LWRT can range from about 200 grams per square meter (gsm) of the GMT or LWRT to about 4000 gsm, although the areal density may be less than 200 gsm or greater than 4000 gsm depending on the specific application needs. In some embodiments, the upper density can be less than 4000 gsm.

In certain examples, one or more of the core layers described herein can be generally prepared using chopped fibers (reinforcing fibers), a thermoplastic material, optionally a lofting agent and/or other materials. For example, a thermoplastic material and any fibers can be added or metered into a dispersing foam contained in an open top mixing tank fitted with an impeller. Without wishing to be bound by any particular theory, the presence of trapped pockets of air of the foam can assist in dispersing the fibers and the thermoplastic material. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web comprising the fibers and the thermoplastic material. The wet web can be passed through a dryer at a suitable temperature to reduce moisture content and to melt or soften the thermoplastic material.

The reinforcement layers, additional layers, decorative layers, etc. can then be applied to the web optionally using an adhesive material between the web and the other layers. The assembly can be passed through one or more sets of rollers to pressure the skins into the web and/or compress the assembly to a desired thickness. The resulting thermoplastic composite article can be cut, sized or otherwise subjected to post-production steps as desired. The machine direction of the process generally refers to the direction of the moving wire screen, whereas the cross direction refers to a direction orthogonal to the machine direction.

In certain configurations, the fiber reinforcement layers described herein can be produced by arranging fibers at a desired angle and then applying a binder material to the fibers to hold them in place. Where multiple plys are used, each individual ply can be produced and then laminated to other plys. The ply or plys can be rolled or used in sheet form as desires.

In certain embodiments, the core layers, skin layers and/or the thermoplastic composite articles described herein can be used to produce interior components or parts or exterior components or parts. For example, the thermoplastic composite article may be present in a vehicular panel, a vehicular underbody panel, an exterior automotive part, an interior automotive part, an automotive headliner, a recreational vehicle panel or a recreational vehicle part. The exact basis weight of each layer present in the various thermoplastic composite articles may vary.

In some configurations, the porous core layer comprising a web of reinforcing fibers held in place by a thermoplastic material comprises a basis weight of 300 gsm to 2500 gsm. The first skin disposed on the porous core layer can have a basis weight of 20 gsm to 250 gsm. The second skin, which comprises a matrix comprising a plurality of arranged fibers held in place by a thermoplastic material, and wherein the second skin provides impact resistance to the thermoplastic composite article and is disposed on the second surface of the porous core layer, comprises a basis weight of 150 gsm to 1200 gsm. The entire composite article can have a basis weight of 500 gsm to 4500 gsm.

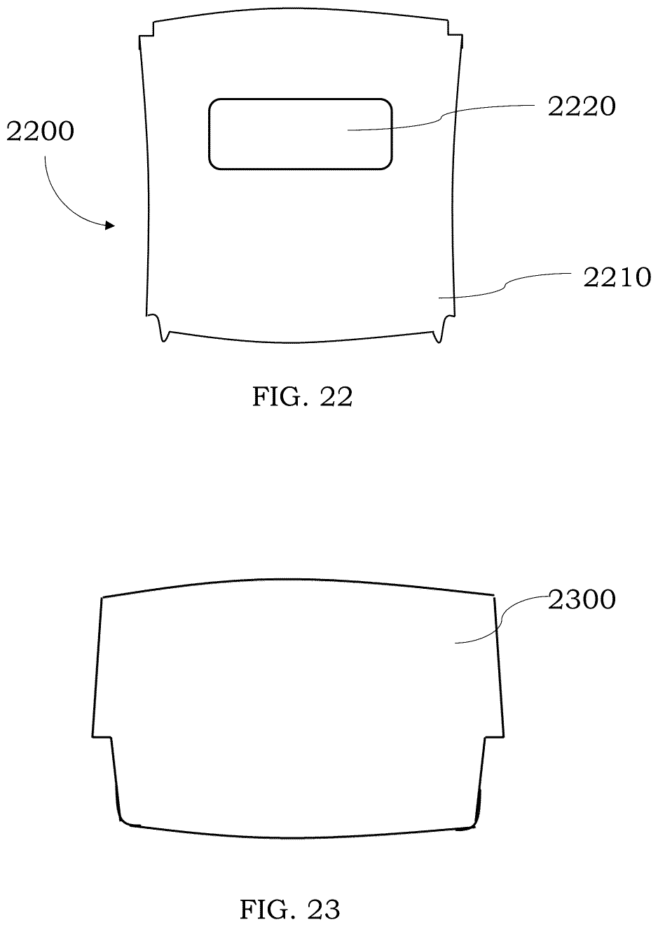

In certain configurations, the core layers, skin layers and/or thermoplastic composite articles described herein can be used to provide a vehicle headliner. Illustrative vehicles include, but are not limited to, automotive vehicles, trucks, trains, subways, recreational vehicles, aircraft, ships, submarines, space craft and other vehicles which can transport humans and/or cargo. In some instances, the headliner typically comprises at least one core layer as described herein and a decorative layer, e.g., a decorative fabric, disposed on the core layer. The decorative layer, in addition to being aesthetically and/or visually pleasing, can also enhance sound absorption and may optionally include foam, insulation or other materials. An illustration of a top view of a headliner is shown in FIG. 22. The headliner 2200 comprises a body 2210 and an opening 2220, e.g., for a sunroof, moonroof, etc., though more than a single opening may be present if desired. The body 2210 of the headliner 2200 can include one or more of the thermoplastic composite articles described herein optionally with decorative layers, fabrics, cloth, etc. The opening 2220 is optional and can be produced by trimming the headliner 2200. The “C” surface or roof side of the headliner typically consists of a non-woven scrim layer for handling purposes. The overall shape and geometry of the headliner 2200 may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle.

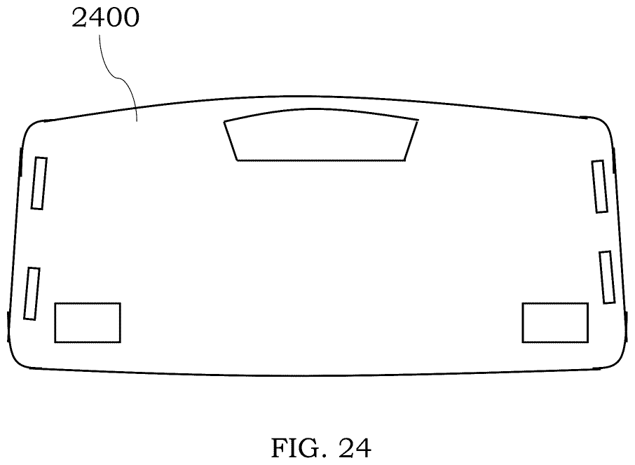

In certain instances, the core layers, skin layers and/or the thermoplastic composite articles described herein can be used to produce underbody shields and rear window trim pieces or parts. An illustration of an underbody shield 2300 is shown in FIG. 23, and an illustration of top view of a rear window trim 2400 is shown in FIG. 24. The particular fiber reinforcement layers used in the underbody shield 2400 and the rear window trim 2400 may be different from the headliner. For example, the underbody shield may comprise the fiber reinforcement layer as an outer layer facing the road to provide impact resistance. The inner surface of the underbody shield, e.g., which sits adjacent to the bottom of the engine may comprise one or more layers designed to absorb and/or retain automotive fluids such as motor oil, antifreeze, brake fluid or the like. While various openings are shown in the rear window trim 2400, the positions and geometries of these openings may vary. In addition, typical rear window trim decorative material may comprise a non-backed PET or PP carpet. The underbody shield 2300 and the window trim 2400 may comprise one or more of the core layers and/or thermoplastic composite articles described herein.

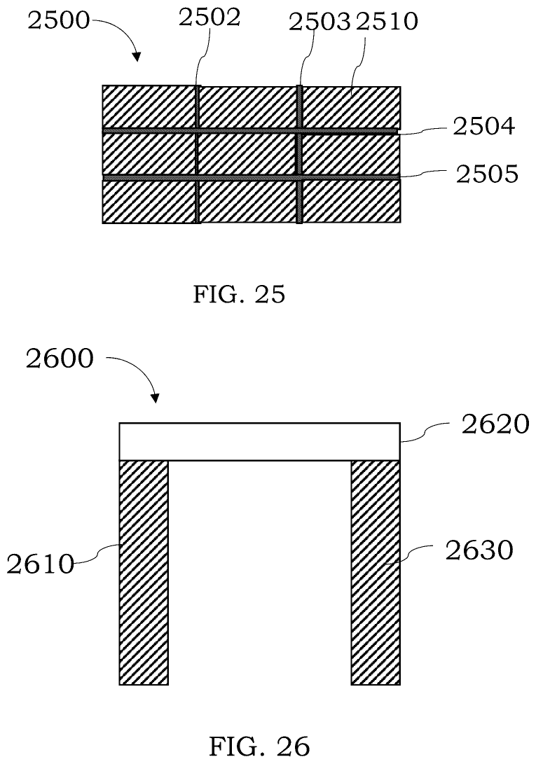

In certain examples, the core layers, skin layers and/or thermoplastic composite articles described herein can be used in composite articles configured for interior use in recreational vehicle panels, wall panels, building panels, roofs, flooring or other applications. In certain examples, the articles described herein can be configured as a ceiling tile. Referring to FIG. 25, a grid of ceiling tiles 2500 is shown that comprises support structures 2502, 2503, 2504 and 2505 with a plurality of ceiling tiles, such as tile 2510, laid into the grid formed by the support structures. In some examples, the ceiling tile comprises one or more of the core layers, reinforcement layers and/or the thermoplastic composite articles described herein. The reinforcement layer of the ceiling tile 2510 may face the environment to provide impact resistance if desired. In some examples, the ceiling tile 2510 may comprise a porous decorative layer, e.g., a fabric, cloth, or other layers, disposed on a porous core layer or a reinforcement layer as described herein.

In other embodiments, the core layers, skin layers and/or thermoplastic composite articles described herein can be used in non-automotive or non-RV parts as well. For example, the thermoplastic composite articles can be used in building applications including roofing, flooring, ceiling tiles or panels, cubicle panels, and other building applications. In certain examples, a cubicle panel may comprise one or more of the core layers, skin layers and/or thermoplastic composite articles. Referring to FIG. 26, a top view of a cubicle 2600 comprising side panels 2610, 2630 and center panel 2620 are shown. Any one or more of the panels 2610-2630 may comprise one of the core layers, reinforcement layers and/or thermoplastic composite articles described herein. The cubicle panel may also comprise one or more decorative layers. In some examples, the cubicle wall panel is sized and arranged to couple to another cubicle wall panel. In certain arrangements, the fiber reinforcement layer of the cubicle wall panel may be exposed to the environment to provide some impact resistance to the cubicle wall panel.

In certain embodiments, the core layers, skin layers and/or thermoplastic composite articles described herein can be present in a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 27, a top view of a structural panel 2710 is shown. The panel 2710 may comprise any one or more of the core layers, skin layers and/or reinforcement layers described herein. If desired, two or more structural panels can be sandwiched with a skin facing into the interior of the room and another skin of the other structural panel facing outward away from the interior of the room. In some instances, the structural panel may also comprise a structural substrate 2820 as shown in FIG. 28. The exact nature of the structural substrate 2820 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. If desired, the structural panel may further comprise a second structural panel coupled to a skin layer of the first structural panel. The fiber reinforcement layer may be facing an open environment such that impact resistance can be provided to the structural panel.

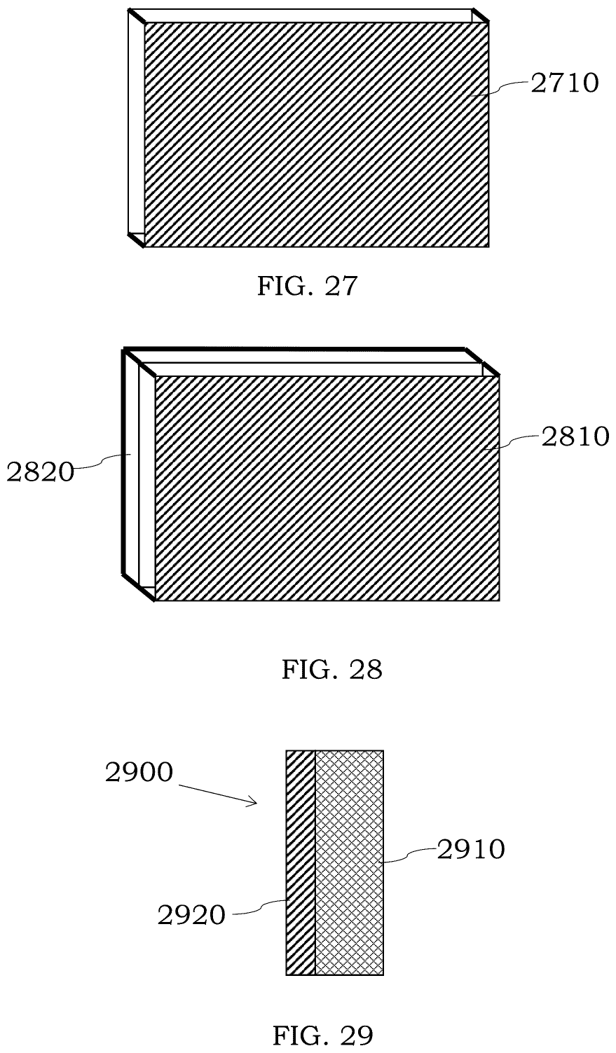

In certain instances, the core layers, skin layers and/or reinforcement layers described herein can be present in a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 29, a side view of a wall panel 2900 is shown. The panel 2900 may comprise one or more of the core layers, skin layers and/or fiber reinforcement layers described herein. For example, the wall panel 2900 may also comprise at least one reinforcement layer 2920 with an angled arrangement of fibers coupled to a first surface of a porous core layer 2910. While not shown, a skin may be placed on a second surface of the core layer 2910. An optional wall substrate can be coupled to a second surface of the porous core layer 2910 and configured to support the porous core layer 2910 when the wall panel 2900 is coupled to a wall surface. In certain configurations, the wall panel 2900 further comprises a porous decorative layer disposed on the layer 2920. In certain embodiments, a second wall panel can be coupled to the panel 2900 if desired.

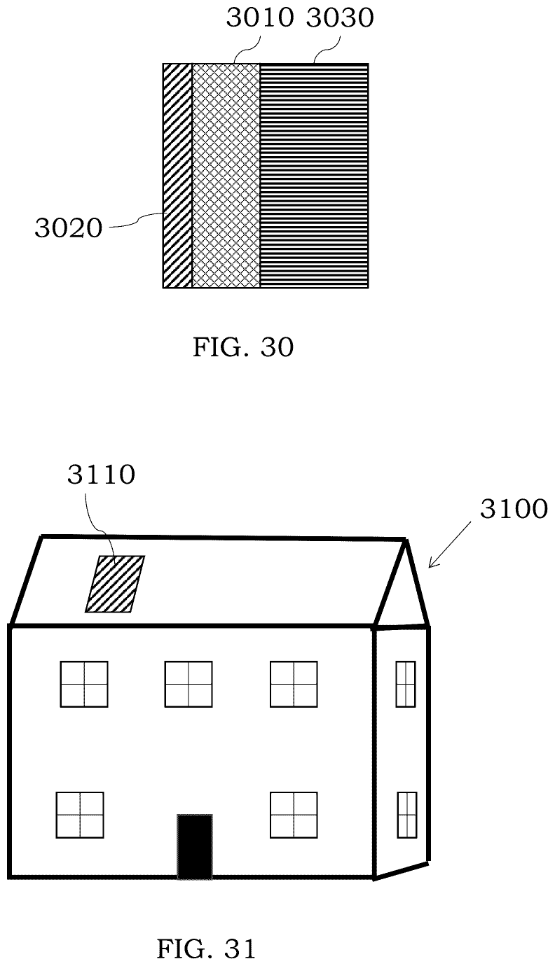

In certain instances, the core layers, reinforcement layers and/or thermoplastic composite articles described herein can be present in a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 30 a side view of a siding panel is shown. The panel may comprise any one or more of the core layers, skin layers and/or thermoplastic composite articles described herein, e.g., a core layer 3010 and a reinforcement layer 3020. A building substrate 3030 can be configured with many different materials including, but not limited to vinyl, wood, brick, concrete, etc. For example, a vinyl substrate can be coupled to the core layer 3010, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the siding panel may further comprise a second siding panel and can be coupled to a second substrate. In some cases, a butt joint, overlapping joint, etc. may exist where the two siding panels can horizontally lock into each other. The reinforcement layer 3020 may be exposed to the environment to provide impact resistance to the siding panel.

In certain instances, the core layers, skin layers and/or thermoplastic composite articles described herein can be present in a roofing panel to be attached to a building such as a residential home or a commercial building. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 31, a perspective view of a roofing panel 3110 attached to a house 3100 is shown. The roofing panel 3110 may comprise any one or more of the core layers, reinforcement layers and/or thermoplastic composite articles described herein. If desired, two or more roofing panels can be sandwiched or otherwise used together. The roofing panel may also comprise a roofing substrate coupled to a first surface of a core layer and can be coupled to a roof of a building to retain the roofing panel to the roof. In some examples, the roofing panel may comprise, or be used with, a weather barrier, e.g., a membrane, house wrap, tar paper, plastic film, etc. In certain instances, the roofing panel comprises a second roofing panel or can be overlapped with, or coupled to, a second roofing panel to prevent moisture from entering into the house 3100. The roofing panel 3110 may be configured with the reinforcement layer exposed to the environment to provide impact resistance to the roofing panel 3110.

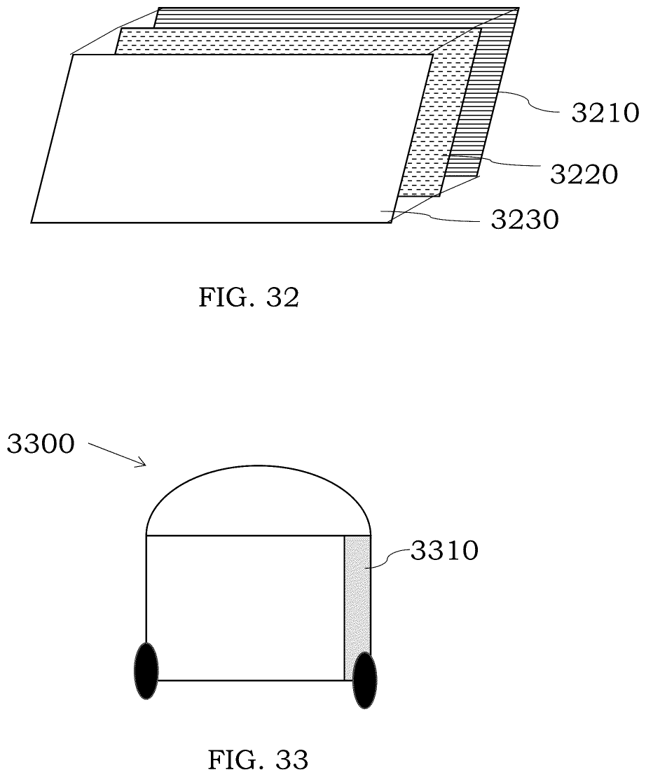

In certain configurations, the core layers, reinforcement layers and/or thermoplastic composite articles described herein can be present in a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 32, an exploded view of a roofing shingle is shown. The roofing shingle 3200 may comprise any one or more of the core layers, reinforcement layers and/or thermoplastic composite articles described herein. If desired, two or more roofing shingles can be sandwiched. In some examples, the roofing shingle may comprise a core layer 3220. If desired, a weatherproof roofing shingle substrate 3230 can be coupled to a first surface and configured to couple to a roofing panel of a building to provide a weatherproof and flame retardant roofing panel. In certain instances, a weather barrier can be coupled to a roofing shingle. In other examples, the roofing shingle comprises asphalt. An intermediate layer 3220, e.g., a skin, insulation or other materials, can be present between the reinforcement layer 3210 and core layer 3220. The reinforcement layer 3210 can be exposed to the environment to provide impact resistance.

In certain configurations, any one or more of the core layers, reinforcement layers and/or thermoplastic composite articles described herein can be present in an interior panel or wall of a recreational vehicle (RV) or an interior panel of an aircraft or aerospace vehicle, e.g., a rocket, satellite, shuttle or other airline or space vehicles. The panel or wall can be used, for example, to cover a skeleton structure on an interior side of the recreational or aerospace vehicle and may be coupled to foam or other insulation materials between the interior and exterior of the vehicle. In some examples, the core layers, skin layers and/or thermoplastic composite articles described herein may be part of a sandwich structure formed from the core layer or article and other layers. If desired, the interior panel can be coupled to another substrate such as, for example, a fabric, plastic, tile, etc.

Referring to FIG. 33, a side view of a recreational vehicle 3300 is shown. The interior panel 3310 may comprise any one or more of the core layers, reinforcement layers and/or thermoplastic composite articles described herein. If desired, two or more RV panels can be sandwiched or coupled together. In some examples, an RV panel may comprise an interior wall substrate that is configured as a decorative layer such as a fabric, a plastic, tile, metal, wood or the like. In additional instances, the RV panel comprises a second RV interior panel which can be the same or different from the RV panel. If desired, the RV panel may comprise a third RV interior panel which may also be the same or different. While not shown, a similar interior panel can be present in aerospace applications/vehicles and may be placed against and/or coupled to an exterior skin such as a metal or metal alloy skin or structure, e.g., aluminum, magnesium, titanium, etc. or other exterior structure. In certain embodiments, the reinforcement layer can be exposed to an interior space of the vehicle to provide impact resistance.

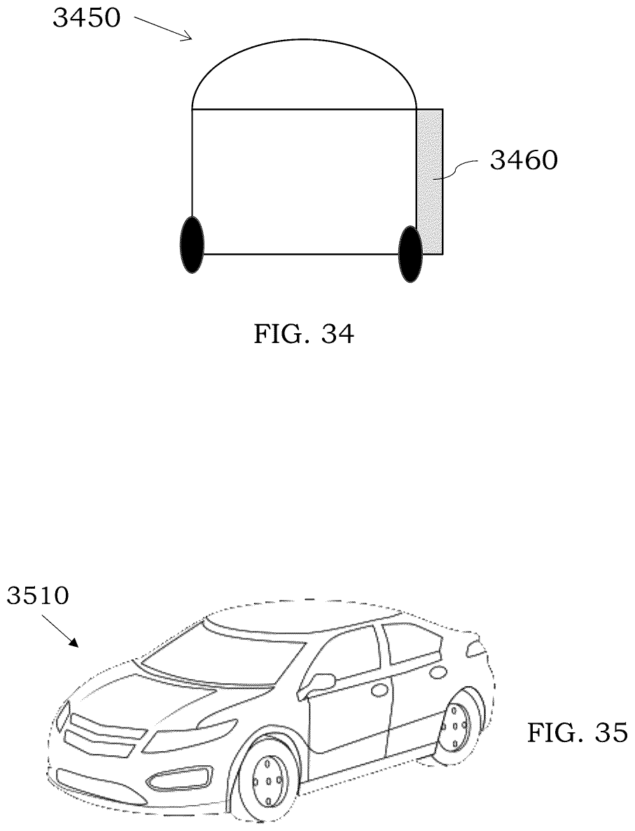

In certain configurations, any one or more of the core layers, reinforcement layers and/or thermoplastic composite articles described herein can be configured as, or present in, an exterior panel or wall of an aircraft vehicle, an aerospace vehicle or a recreational vehicle. The panel or wall can be used, for example, to cover a skeleton structure on an exterior side of the vehicle and may be coupled to foam or other insulation materials between the interior and exterior of the vehicle. In some examples, the core layer or article may be part of a sandwich structure formed from the core layer or article and other layers. If desired, the exterior panel can be coupled to another substrate such as, for example, a metal, a metal alloy, fiberglass, etc. Referring to FIG. 34, a side view of a recreational vehicle 3450 is shown that comprises an exterior panel 3460, which can be configured as any one of the core layers, skin layers and/or thermoplastic composite articles described herein. If desired, two or more RV panels can be sandwiched with a skin facing into the interior of the RV and a skin of the other RV panel facing outward away from the interior of the RV. In certain configurations, the exterior wall substrate comprises glass fibers or is configured as a metal panel such as aluminum or other metal materials. If desired, the reinforcement layer can be placed adjacent to the exterior wall substrate to enhance impact resistance. In additional instances, the RV panel comprises a second RV exterior panel which can be the same or different from the RV panel. If desired, the RV panel may comprise a third RV exterior panel which may also be the same or different. While not shown, a similar exterior panel can be present in aerospace applications/vehicles and may be placed against and/or coupled to an interior skin or structure such as an interior metal or metal alloy skin, e.g., aluminum, magnesium, titanium, etc., or other interior structure.

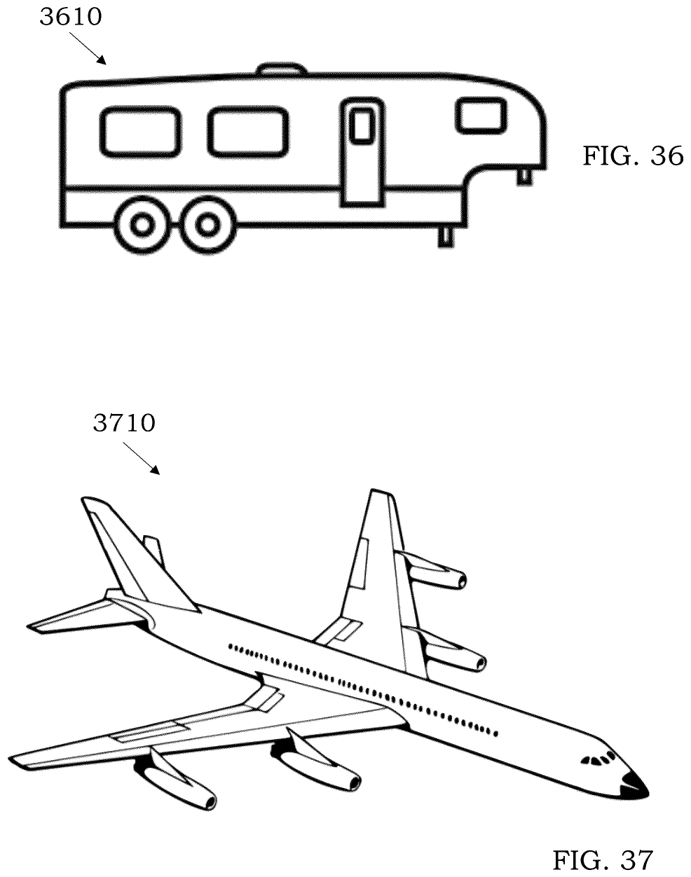

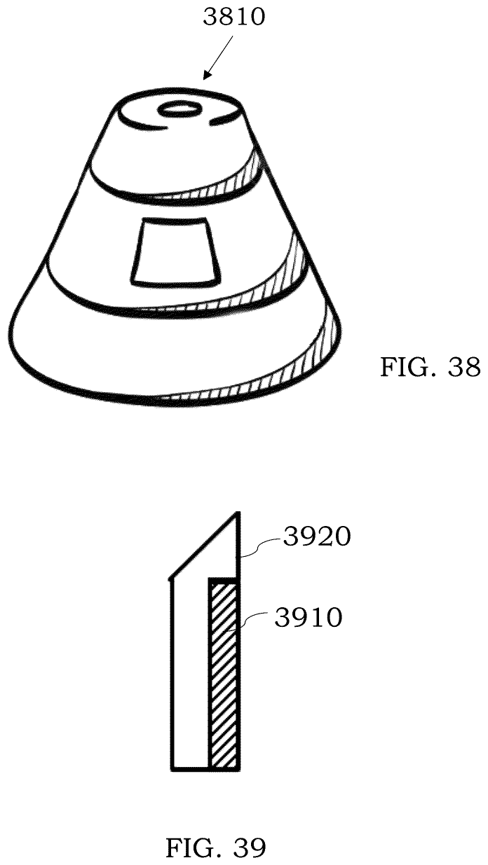

In certain examples, the core layers, reinforcement layers and/or thermoplastic composite articles described herein can be used in an automotive vehicle 3510 (FIG. 35), a recreational vehicle 3610 (FIG. 36), an airplane 3710 (FIG. 37), a space capsule 3810 (FIG. 38), a rocket, a satellite, or other vehicles which comprise one or more wheels, an engine, a motor, a turbine, a rocket, a fuel cell, a battery, are solar powered, are powered by wind, are gas propelled or have a motive means which can be used to propel the vehicle. As shown in FIG. 36, however, vehicles with the core layers, reinforcement layers and/or thermoplastic composite articles described herein may be towed behind or coupled to another vehicle if desired and may not have an independent motor or engine to propel them.

In some examples, the core layers, reinforcement layers and/or thermoplastic composite articles described herein can be used as interior trim applications, e.g., RV interior trim, interior trim for building or for automotive applications. The interior trim can be coupled to other materials, such as, for example, wood, PVC, vinyl, plastic, leather or other materials. A side view illustration of a trim piece that can be used as baseboard trim is shown in FIG. 39. The trim piece comprises a trim substrate 3920. The trim piece may be nailed or otherwise attached to a stud or wallboard 3910 as desired. The substrate 3920 faces outward and is viewable within a room, and the reinforcement layer typically faces into the interior of the room. The trim piece can be curved or may take two or three dimensional shapes as desired. If desired, one or more decorative skins may be present on an outside of the trim piece and facing into the interior of the room.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. An impact resistant thermoplastic composite article comprising:
a porous core layer comprising a web of reinforcing fibers held in place by a thermoplastic material;
a first skin disposed on a first surface of the porous core layer; and
a second skin disposed on a second surface of the porous core layer, wherein the second skin comprises a matrix comprising a plurality of arranged fibers held in place by a thermoplastic material, and wherein the second skin provides impact resistance to the thermoplastic composite article to permit the thermoplastic composite article to pass a gravelometer test.

2. The impact resistant thermoplastic composite article of claim 1, wherein the plurality of arranged fibers of the second skin comprise a unidirectional arrangement of the fibers in a single ply or in at least two plys.

3. The impact resistant thermoplastic composite article of claim 2, wherein the plurality of arranged fibers of the second skin are selected from the group consisting of glass fibers, carbon fibers, organic fibers, inorganic fibers, bicomponent fibers, and combinations and blends thereof.

4. The impact resistant thermoplastic composite article of claim 1, wherein the plurality of arranged fibers of the second skin comprise a bidirectional arrangement of the fibers in a single ply or in at least two plys.

5. The impact resistant thermoplastic composite article of claim 4, wherein the plurality of arranged fibers of the second skin are selected from the group consisting of glass fibers, carbon fibers, organic fibers, inorganic fibers, bicomponent fibers and combinations and blends thereof.

6. The impact resistant thermoplastic composite article of claim 1, wherein the porous core layer comprises a basis weight between 300 gsm and 2000 gsm or between 450 gsm and 1400 gsm.

7. The impact resistant thermoplastic composite article of claim 6, wherein the first skin is a scrim or a film comprising a basis weight from 15 gsm to 110 gsm.

8. The impact resistant thermoplastic composite article of claim 7, wherein the second skin comprises a basis weight up to 500 gsm, and wherein the thermoplastic material of the second skin is polypropylene, polyethylene terephthalate or an amorphous polyethylene terephthalate.

9. The impact resistant thermoplastic composite article of claim 1, wherein the thermoplastic material of the porous core layer comprises at least one of a polyethylene, a polypropylene, a polystyrene, a polyimide, a polyetherimide, an acrylonitrylstyrene, a butadiene, a polyethylene terephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures and copolymers thereof.

10. The impact resistant thermoplastic composite article of claim 1, wherein the reinforcing fibers of the porous core layer are selected from the group consisting of glass fibers, carbon fibers, graphite fibers, synthetic organic fibers, inorganic fibers, bicomponent fibers, natural fibers, mineral fibers, metal fibers, metalized inorganic fibers, metalized synthetic fibers, ceramic fibers, and combinations and blends thereof.

11. The impact resistant thermoplastic composite article of claim 1, further comprising an adhesive tie layer between the second skin and the second surface of the porous core layer.

12. The impact resistant thermoplastic composite article of claim 11, wherein the adhesive tie layer comprises a thermoplastic material.

13. The impact resistant thermoplastic composite article of claim 12, wherein the thermoplastic material of the adhesive tie layer comprises a polyolefin.

14. The impact resistant thermoplastic composite article of claim 13, wherein the plurality of arranged fibers of the second skin comprise a unidirectional arrangement of the fibers in a single ply or in at least two plys.

15. The impact resistant thermoplastic composite article of claim 14, wherein the plurality of arranged fibers of the second skin are selected from the group consisting of glass fibers, carbon fibers, organic fibers, inorganic fibers, bicomponent fibers, and combinations and blends thereof.

16. The impact resistant thermoplastic composite article of claim 13, wherein the plurality of arranged fibers of the second skin comprise a bidirectional arrangement of the fibers in a single ply or in at least two plys.

17. The impact resistant thermoplastic composite article of claim 16, wherein the plurality of arranged fibers of the second skin are selected from the group consisting of glass fibers, carbon fibers, organic fibers, inorganic fibers, bicomponent fibers and combinations and blends thereof.

18. The impact resistant thermoplastic composite article of claim 13, wherein the porous core layer comprises a basis weight between 300 gsm and 1000 gsm or between 300 gsm and 800 gsm.

19. The impact resistant thermoplastic composite article of claim 18, wherein the first skin is a scrim or a film comprising a basis weight up to 20 gsm.

20. The impact resistant thermoplastic composite article of claim 19, wherein the second skin comprises a basis weight up to 500 gsm, and wherein the thermoplastic material of the second skin is polypropylene, polyethylene terephthalate or an amorphous polyethylene terephthalate.

21-31. (canceled)
